(19) United States
(12) Patent Application Publication
(10) Pub. No.: US 2010/0319624 A1
(43) Pub. Date: Dec. 23, 2010

(54) K 9 Pit Stop

(76) Inventor: James Devereaux, JR., Dallas, TX (US)

Correspondence Address: WILSON DANIEL SWAYZE, JR., 3804 CLEARWATER CT., PLANO, TX, 75025, US

(21) Appl. No.: 12/819,927

(22) Filed: Jun. 21, 2010

Related U.S. Application Data
(60) Provisional application No. 61/269,150, filed on Jun. 22, 2009.

(51) Int. Cl. A01K 29/00

(52) U.S. Cl. 119/162

(57) ABSTRACT

A platform for an animal may include a base plate to cooperate with a toilet, a lower frame structure to support the base plate, and a ladder to allow the animal to reach the base plate. The base plate may include a curved portion to cooperate with the toilet bowl and the height of the lower frame structure may be adjustable. The ladder may be detachably connected to the lower frame structure, and the ladder may be detachably connected to a front of the lower frame structure. The ladder may be detachably connected to a side of the lower frame structure, and the top of the base plate may include a non-slip surface. The base plate may include a central aperture to define a handle, and the base plate may include a fastener to hold an absorbent sheet. The height of the ladder may be adjustable.

### PRIORITY

The present invention claims priority based upon a provisional application with a Ser. No. 61/269,150 which was filed on Jun. 22, 2009.

### FIELD OF THE INVENTION

The present invention relates to an accessory to be used with the conventional toilet and more particularly to a platform that can assist animals, particularly small four-footed animals to place their waste within the toilet.

### BACKGROUND

At the present time, it is well-recognized that a provision must be made for accommodating dogs or other small animals to literally “go to the toilet”. This is true not only in larger cities, but smaller ones as well, where laws make it mandatory for the owner of the dog in taking him for a walk to pick up defecated matter in a bag and dispose of it. Moreover, the burden of taking the dog for a walk must be borne by all dog owners, as required by leash laws which prohibit letting the dog take care of himself.

The desirability of providing a specialized design flushable toilet for dogs has been recognized during recent years and has received the attention of several inventors working in this field. However, these specially designed toilets may be expensive and may occupy valuable space within an otherwise small bathroom. The housing and care of animals in an urban environment, particularly of small domestic animals such as dogs, presents many problems. Most condominium and rental units have strict regulations for the control of animal pets to prevent them from wandering in the building and causing unwanted noises and odors. The usual solution is to permit the pet to have the run of at least part of the unit, with the hope that its toilet training is adequate, and that it will not become agitated to the extent that it will cause damage to furniture and/or make excessive noise.

### SUMMARY

A platform for an animal may include a base plate to cooperate with a toilet, a lower frame structure to support the base plate, and a ladder to allow the animal to reach the base plate.

The base plate may include a curved portion to cooperate with the toilet bowl and the height of the lower frame structure may be adjustable.

The ladder may be detachably connected to the lower frame structure, and the ladder may be detachably connected to the front of the lower frame structure.

The ladder may be detachably connected to a side of the lower frame structure, and the top of the base plate may include a non-slip surface.

The base plate may include a central aperture to define a handle, and the base plate may include a fastener to hold an absorbent sheet.

The height of the ladder may be adjustable.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the platform of the present invention;

FIG. 2 illustrates a perspective view of the height adjustment device of the present invention;

FIG. 3 illustrates a top view of the platform of the present invention;

FIG. 4 illustrates a side view of the platform of the present invention;

FIG. 5 illustrates a perspective view of the bottom of the platform of the present invention;

FIG. 6 illustrates a back view of the platform of the present invention;

FIG. 7 illustrates a front view of the platform of the present invention;

FIG. 8 illustrates a perspective view of the platform in use with a toilet;

FIG. 9 illustrates a perspective view of another embodiment of the platform in use with the toilet.

### DETAILED DESCRIPTION

The present invention provides a device or platform which may cooperate with a conventional toilet and which may be removable, replaceable and storable in order to be used in small and large bathrooms and may be used by different types of small animals. The present invention is especially advantageous for dogs because of the need for dogs to be walked in order to eliminate the waste from the dogs. The platform 100 is sufficiently flexible that the platform 100 may be used with a bucket or other type of container.

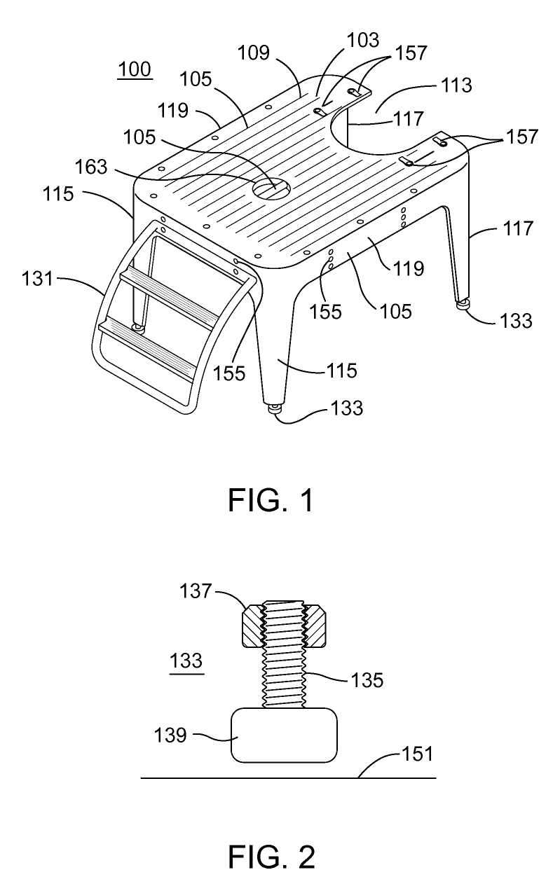

FIG. 1 illustrates a perspective view of the platform 100 without the toilet and illustrates base plate 101 which may have a top surface 103 which may include anti-skid elements 107 to prevent the animal from slipping on the upper surface 103. The base plate 101 may be connected or detachably connected for example by fasteners such as screws to the lower frame structure 105. The base plate 101 may be formed from rigid material such as wood, metal, plastic or could be formed integrally with the lower frame structure 105. The upper surface 103 may be connected to a side surface 109 which may extend around the periphery of the base plate 101. The side surface 109 may include a curved portion 111 which may form a depression 113 in the rear of the base plate 101 in order to cooperate with the opening of the toilet bowl with the seat extending upwards. The depression 113/cut out may be sized to form a substantially seamless connection with the seat rim of the toilet in order to prevent waste from flowing down the edge of the toilet. The lower frame structure 105 may include a pair of opposing front legs 115 and may include a pair of opposing back legs 117, and the lower frame structure 105 may include a side wall 119 on opposing sides of the lower frame structure 105 to support the front legs 115 and the back legs 117 and the base plate 101. The sidewall 119 may include a row of apertures 155 extending in the vertical direction in order to provide for attachment to the ladder 131 and to provide for a variable height adjustment for the ladder 131 in order to compensate for changes in height in the platform 100. The legs 115, 117 may include a height adjustment device 133 to allow the platform 100 to be raised and lowered in according to the requirements of the animal and the toilet. The height adjustment device 133 may include a threaded shaft 135 and an internally threaded nut 137 which may cooperate with the threaded shaft 135 and which may be connected to the end of the legs 115, 117. The threaded shaft 115 may terminate in a padded foot 139 to prevent damage to the floor/support surface 151. The threaded shaft 115 may be rotated to lower or raise the platform 100.

The lower frame structure 105 may include a front wall 153 which may extend between opposing front legs 115. The front wall 153 may include a row of apertures 155 extending in the vertical direction in order to provide for attachment to the ladder 131 and to provide for a variable height adjustment for the ladder 131 in order to compensate for changes in height in the platform 100. The ladder 131 may be connected to the front wall 153 or the sidewall 119. The lower frame structure 105 may not have a back wall in order to accommodate the toilet bowl.

The base plate 101 may be connected to fasteners 157/clamps which may rotate and which may be flexible to permit movement in the axial direction. The fasteners 157 may position and clamp a sheet of absorbent material 161 in order that the animal may train with conditions which may be similar to the outside. The fasteners 157 may be rotated or may be axially moved to replace the absorbent material 161.

The base plate 101 may include a central aperture 163 and a handle 165 to allow the platform 100 to be carried easily.

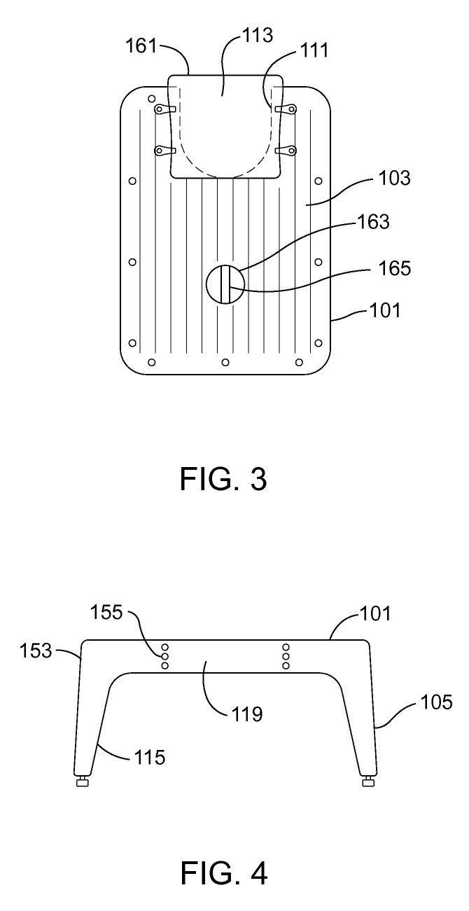

FIG. 3 illustrates a top view of the base plate 101, the depression 113, the curve portion 111 which may define the depression 113 and the top surface 103 of the base plate 101 and illustrates the substantially central aperture 163 and the handle 165.

FIG. 4 illustrates a side view of the platform 100 and illustrates the base plate 101 positioned over the lower frame structure 105. The lower frame structure 105 may include a front wall 153 which may extend between opposing front legs 115. The front wall 153 may include a row of apertures 155 extending in the vertical direction in order to provide for attachment to the ladder 131 and to provide for a variable height adjustment for the ladder 131 in order to compensate for changes in height in the platform 100. The ladder 131 may be connected to the front wall 153 or the sidewall 119. The lower frame structure 105 may not have a back wall in order to accommodate the toilet bowl.

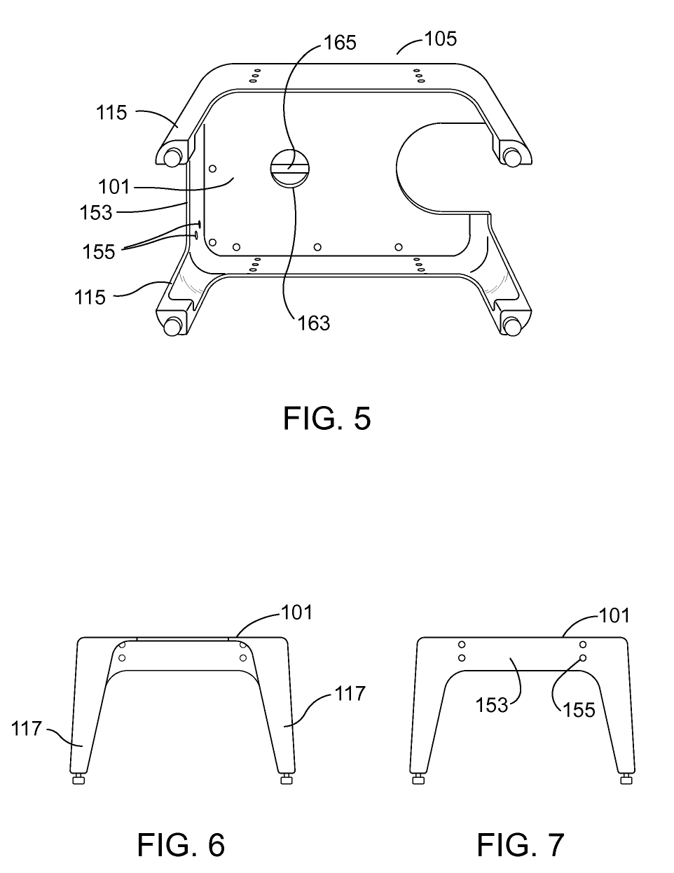

FIG. 5 illustrates a perspective bottom view and illustrates the base plate 101 positioned over the lower frame structure 105. The lower frame structure 105 may include a front wall 153 which may extend between opposing front legs 115. The front wall 153 may include a row of apertures 155 extending in the vertical direction in order to provide for attachment to the ladder 131 (not shown) and to provide for a variable height adjustment for the ladder 131 in order to compensate for changes in height in the platform 100. The ladder 131 may be connected to the front wall 153 or the sidewall 119. The sidewall 119 may have the vertical rows of apertures 115 to provide for the above variable height adjustment and to allow the animal to access the base plate 101 from the side. This may be advantageous in small bathrooms. The lower frame structure 105 may or may not have a back wall in order to accommodate the toilet bowl. FIG. 5 additionally illustrates the bottom surface 171 of the base plate 101 and illustrates the substantially central aperture 163 and the handle 165.

FIG. 6 illustrates a back view of the base plate 101 and illustrates the back legs 117.

FIG. 7 illustrates a front view of the base plate 101 and illustrates the front wall 153 and the apertures 155 which may have multiple apertures in the horizontal and vertical directions.

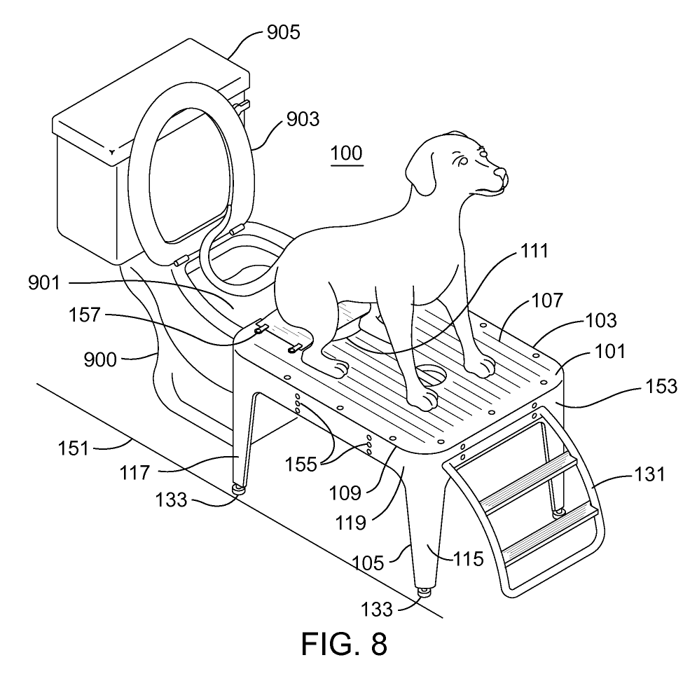

FIG. 8 illustrates a perspective view of the platform 100 with the toilet 900 which may include a toilet bowl 901, a toilet seat 903 and a toilet tank 905 and illustrates base plate 101 which may have a top surface 103 which may include anti-skid elements 107 to prevent the animal from slipping on the upper surface 103. The base plate 101 may be connected or detachably connected for example by fasteners such as screws to the lower frame structure 105. The base plate 101 and the lower frame structure 105 may be formed from rigid material such as wood, metal, plastic or could be formed integrally with the lower frame structure 105. The upper surface 103 may be connected to a side surface 109 which may extend around the periphery of the base plate 101. The side surface 109 may include a curved portion 111 which may form a depression 113 in the rear of the base plate 101 in order to cooperate with the opening of the toilet bowl with the seat 903 extending upwards. The depression 113/cut out may be sized to form a substantially seamless connection with the seat rim of the toilet in order to prevent waste from flowing down the edge of the toilet. The lower frame structure 105 may include a pair of opposing front legs 115 and may include a pair of opposing back legs 117, and the lower frame structure 105 may include a side wall 119 on opposing sides of the lower frame structure 105 to support the front legs 115 and the back legs 117 and the base plate 101. The sidewall 119 may include a row of apertures 155 extending in the vertical direction in order to provide for attachment to the ladder 131 and to provide for a variable height adjustment for the ladder 131 in order to compensate for changes in height in the platform 100. The legs 115, 117 may include a height adjustment device 133 to allow the platform 100 to be raised and lowered in according to the requirements of the animal and the toilet 900. The height adjustment device 133 may include a threaded shaft 135 and an internally threaded nut 137 which may cooperate with the threaded shaft 135 and which may be connected to the end of the legs 115, 117. The threaded shaft 115 may terminate in a padded foot 139 to prevent damage to the floor/support surface 151. The threaded shaft 115 may be rotated to lower or raise the platform 100.

The lower frame structure 105 may include a front wall 153 which may extend between opposing front legs 115. The front wall 153 may include a row of apertures 155 extending in the vertical direction in order to provide for attachment to the ladder 131 and to provide for a variable height adjustment for the ladder 131 in order to compensate for changes in height in the platform 100. The ladder 131 may be connected to the front wall 153 or the sidewall 119. The lower frame structure 105 may not have a back wall in order to accommodate the toilet bowl.

The base plate 101 may be connected to fasteners 157/clamps which may rotate and which may be flexible to permit movement in the axial direction. The fasteners 159 may position and clamp a sheet of absorbent material 161 in order that the animal may train with conditions which may be similar to the outside.

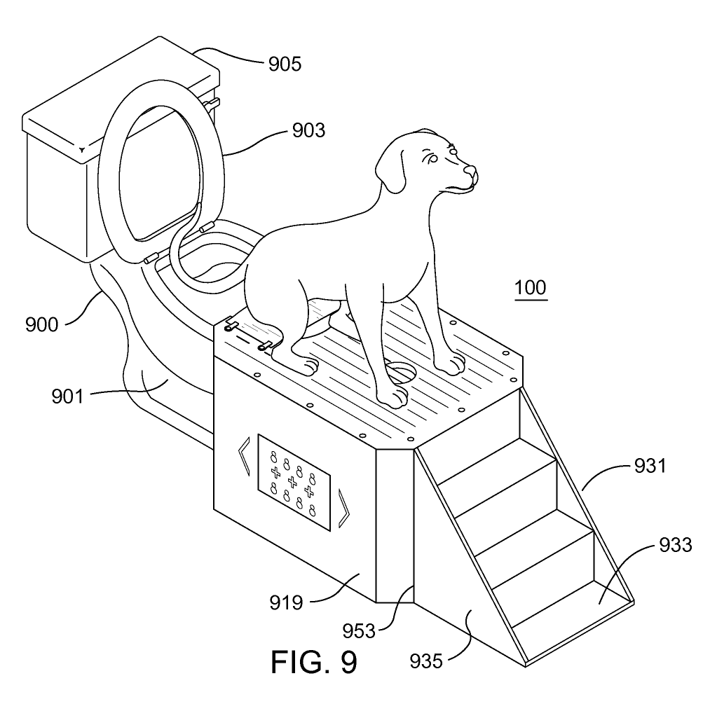

FIG. 9 illustrates a perspective view of the platform 100 and the toilet 900. FIG. 9 illustrates that the sidewall 919 and the front wall 953 extend to the support surface 151 and illustrates a staircase 931 which may include steps 933 and staircase sidewalls 935.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A platform for an animal, comprising:
a base plate to cooperate with a toilet;
a lower frame structure to support the base plate;
a ladder to allow the animal to reach the base plate;
wherein the base plate includes a curved portion to cooperate with the toilet bowl.

2) A platform for an animal as in claim 1, wherein the height of the lower frames structure is adjustable.

3) A platform for an animal as in claim 1, wherein the ladder is detachably connected to the lower frame structure.

4) A platform for an animal as in claim 3, wherein the ladder is detachably connected to a front of the lower frame structure.

5) A platform for an animal as in claim 3, wherein the ladder is detachably connected to a side of the lower frame structure.

6) A platform for an animal as in claim 1, wherein the top of the base plate includes a non-slip surface.

7) A platform for an animal as in claim 1, wherein the base plate includes a central aperture to define a handle.

8) A platform for an animal as in claim 1, wherein the base plate includes a fastener to hold an absorbent sheet.

9) A platform for an animal as in claim 1, wherein the height of the ladder is adjustable.
